(19) United States
(12) Patent Application Publication
(10) Pub. No.: US 2018/0115732 A1
(43) Pub. Date: Apr. 26, 2018

(54) Receiver and image processing method used in image transmission system

(71) Applicant: Haoxiang Electric Energy (Kunshan) Co., Ltd., Kunshan (CN)

(72) Inventors: Yu Tian, Kunshan (CN); Wenyan Jiang, Kunshan (CN)

(73) Assignee: Haoxiang Electric Energy (Kunshan) Co., Ltd.

(21) Appl. No.: 15/851,522

(22) Filed: Dec. 21, 2017

(30) Foreign Application Priority Data
Dec. 21, 2016 (CN) 201611189821.X

(51) Int. Cl. H04N 5/44; H04N 5/38

(52) U.S. Cl. CPC H04N 5/44; G05D 1/0038; H04N 5/38

(57) ABSTRACT

A receiver and an image processing method used in an image transmission system are provided, wherein the image transmission system includes a transmitter and the receiver; the receiver includes: a data receiving unit for receiving a series of data encapsulations corresponding to a series of images from the transmitter; a data buffering unit for buffering a pre-determined number of the data encapsulations according to a time order; and a data decoding unit for decoding at least a part of the pre-determined number of the data encapsulations. According to the present invention, the receiver and the image processing method used in the image transmission system decrease buffered data encapsulations, so as to decrease image transmission delay and achieve image transmission in almost real time.

### CROSS REFERENCE OF RELATED APPLICATION

The present invention claims priority under 35 U.S.C. 119(a-d) to CN 201611189821.X, filed Dec. 21, 2016.

### BACKGROUND OF THE PRESENT INVENTION

### Field of Invention

The present invention relates to a technical field of image processing, and more particularly to a receiver and an image processing method used in an image transmission system.

### Description of Related Arts

Unmanned Aerial Vehicle (UAV) flies with a ground-based wireless remote-control system or an integrated automatic control system, having advantages such as small size, low cost, light weight, convenient operation, and high flight flexibility, which can adapt to many harsh environments where manned aircraft cannot adapt. Therefore, UAV is widely used in military, civil, and scientific research as well as other related fields.

UAV system comprises a flight control system, a holder+camera system, and an image transmission system, wherein the flight control system is used to control the UAV to complete a complete flight process including taking off, flying, and returning; the holder+camera system captures images from different angles of a specified scene during flight; the image transmission system sends the imaged captured by the holder+camera system during flight to ground for viewing.

However, in most cases, the image transmission system cannot transmit the images collected by the holder+camera system to the ground in real time, and usually there is a certain transmission delay, which may more or less affect ground staff to use the UAV.

### SUMMARY OF THE PRESENT INVENTION

An object of the present invention is to provide a receiver and an image processing method used in an image transmission system, so as to decrease image transmission delay and achieve image transmission in almost real time.

Accordingly, in order to accomplish the above object, the present invention provides a receiver used in an image transmission system, wherein the image transmission system comprises a transmitter and the receiver; the receiver comprises:

a data receiving unit for receiving a series of data encapsulations corresponding to a series of images from the transmitter;

a data buffering unit for buffering a pre-determined number of the data encapsulations according to a time order; and

a data decoding unit for decoding at least a part of the pre-determined number of the data encapsulations.

Preferably, if a new data encapsulation is received before a first data encapsulation of the pre-determined number of the data encapsulations is decoded by the data decoding unit, the data buffering unit discards the first data encapsulation and buffers the new data encapsulation.

Preferably, after a decoding process of a current data encapsulation is completed, the data decoding unit ignores other data encapsulations in the pre-determined number of the data encapsulations and decodes the new data encapsulation.

Preferably, the data decoding unit decodes the part of the pre-determined number of the data encapsulations, and a first pre-determined interval exists between receiving times of adjacent data encapsulations in the part of the pre-determined number of the data encapsulations.

Preferably, a second pre-determined interval exists between receiving times of adjacent data encapsulations in the pre-determined number of the data encapsulations.

The present invention also provides an image processing method used in an image transmission system, comprising steps of:

receiving a series of data encapsulations corresponding to a series of images;

buffering a pre-determined number of the data encapsulations according to a time order; and

decoding at least a part of the pre-determined number of the data encapsulations.

Preferably, if a new data encapsulation is received before a first data encapsulation of the pre-determined number of the data encapsulations is decoded, the first data encapsulation is discarded and the new data encapsulation is buffered.

Preferably, after a decoding process of a current data encapsulation is completed, other data encapsulations in the pre-determined number of the data encapsulations are ignored and the new data encapsulation is decoded.

Preferably, the part of the pre-determined number of the data encapsulations are decoded, and a first pre-determined interval exists between receiving times of adjacent data encapsulations in the part of the pre-determined number of the data encapsulations.

Preferably, a second pre-determined interval exists between receiving times of adjacent data encapsulations in the pre-determined number of the data encapsulations.

According to the present invention, the receiver and the image processing method used in the image transmission system decrease buffered data encapsulations, so as to decrease image transmission delay and achieve image transmission in almost real time.

### BRIEF DESCRIPTION OF THE DRAWINGS

Other features, objects, and advantages of the present invention will become more apparent by reading the following detailed description of the non-limiting embodiments with reference to the attached drawings in which the same or similar reference signs denote the same or similar features.

FIG. 1 is a flow chart illustrating an image processing method used in an image transmission system according to an embodiment of the present invention;

FIG. 2 is a block diagram showing a receiver used in the image transmission system according to the embodiment of the present invention; and

FIG. 3 is a block diagram showing a hardware architecture of a computing device capable of implementing the image processing method shown in FIG. 1 and the receiver shown in FIG. 2.

### DETAILED DESCRIPTION OF THE PREFERRED EMBODIMENT

The features and exemplary embodiments of the various aspects of the present invention are described in detail below. In the following detailed description, numerous specific details are set forth in order to provide a thorough understanding of the present invention. However, it will be apparent to one skilled in the art that the present invention may be practiced without some of these specific details. The following description of the embodiments is merely for providing a better understanding of the present invention by showing examples of the present invention. The present invention is in no way limited to any particular configuration and algorithm set forth below, but covers any alterations, substitutions and improvements of the elements, components and algorithms without departing from the spirit of the present invention. In the drawings and the following description, well-known structures and techniques are not shown in order to avoid unnecessarily obscuring the present invention.

With the rise of various wireless communication technologies, wireless image transmission technology has been widely used in UAV systems because of flexible use and convenient operation. Conventional wireless image transmission technologies include analog image transmission technology and digital image transmission technology, in which analog image transmission technology has been gradually replaced by digital image transmission technology due to poor image quality and serious influence of weather and electromagnetic environment. However, neither analog image transmission technology nor digital image transmission technology can provide real-time transmission of images, and usually there is a certain transmission delay.

In general, an image transmission system in a UAV system comprises a transmitter located on a UAV and a receiver located on a ground. The transmitter receives images from a video camera/camera mounted on the UAV and wirelessly transmits the images to the receiver. Specifically, in a case of digital image transmission technology, the transmitter generates a data encapsulation corresponding to a frame by encoding the frame, and transmits the data encapsulation to the receiver by radio signals in a specified frequency range. The receiver decodes the received data encapsulation to recover the frame corresponding to the data encapsulation. Transmission delay in the image transmission system is mainly caused by encoding and decoding the images.

In view of the above aspects, the present invention provides a receiver and an image processing method used in an image transmission system, so as to decrease image transmission delay and achieve image transmission in almost real time. Hereinafter, the image processing method and the receiver used in the image transmission system according to an embodiment of the present invention are described in detail with reference to the accompanying drawings.

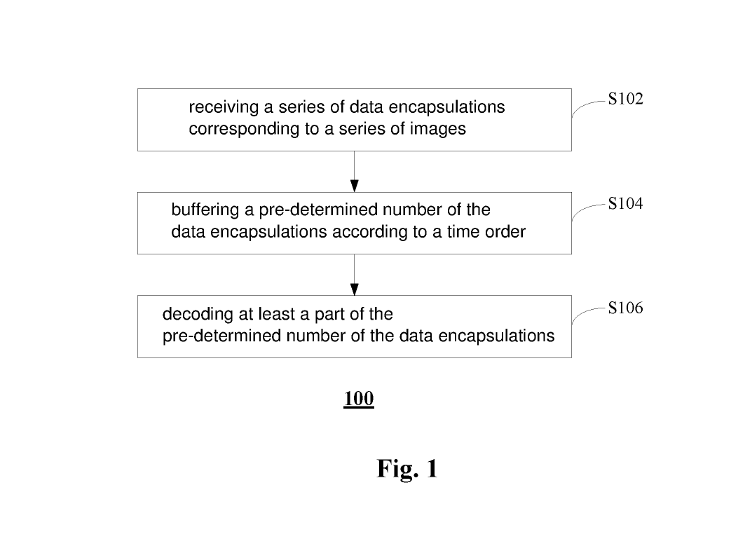

FIG. 1 is a flow chart illustrating an image processing method used in an image transmission system according to an embodiment of the present invention. Referring to FIG. 1, the image processing method 100 used in the image transmission system according the embodiment of the present invention comprises steps of: S102: receiving a series of data encapsulations corresponding to a series of images; S104: buffering a pre-determined number of the data encapsulations according to a time order; and S106: decoding at least a part of the pre-determined number of the data encapsulations.

According to the embodiment of the present invention, the image processing method 100 does not need to decode all the data encapsulations corresponding to the images, so as to decrease image transmission delay and achieve image transmission in almost real time.

Preferably, if a new data encapsulation is received before a first data encapsulation of the pre-determined number of the data encapsulations is decoded, the first data encapsulation is discarded and the new data encapsulation is buffered. In such case, the pre-determined number of the data encapsulations may be decoded according to a buffering time order, or after a decoding process of a current data encapsulation is completed, other data encapsulations in the pre-determined number of the data encapsulations are ignored and the new data encapsulation is decoded. As a result, it is ensured that latest data encapsulations are buffered and decoded, so as to further improve real-time capability of image transmission.

Preferably, the part of the pre-determined number of the data encapsulations may be decoded, which can be a first half, a second half, a middle part, or discontinuously received ones of the pre-determined number of the data encapsulations.

For example, if N (N is an integer larger than 0) data encapsulation are buffered, the N data encapsulation can be decoded as follows: 1) decoding No. 1, 3, 5, 7 . . . data encapsulations; 2) decoding No. 2, 4, 6, 8 . . . data encapsulations; decoding first N/2 data encapsulations; 4) decoding second N/2 data encapsulations; 5) decoding middle N/3 data encapsulations; etc. In the case 1) and 2), a first pre-determined interval exists between receiving times of adjacent data encapsulations in the part of the pre-determined number of the data encapsulations.

It should be understood by persons skilled in the art that when decoding the part of the pre-determined number of the data encapsulations, the part is not limited to the those described above, and may also be other parts.

Preferably, when receiving a series of the data encapsulations corresponding to a series of the images, the data encapsulations can be buffered in sequence, or buffered once after skipping several data encapsulations or a certain period. For example, a first data encapsulation is buffered after being received, a second and a third data encapsulations are discarded after being received, and then a fourth data encapsulation is buffered after being received; or, a first data encapsulation is buffered after being received, no data encapsulation is buffered within next 50 ms, and then a new data encapsulation is buffered after being received, and so on. That is to say, a second pre-determined interval may exist between receiving times of adjacent data encapsulations in the pre-determined number of the data encapsulations. It should be understood that the first interval may equal to the second interval or not.

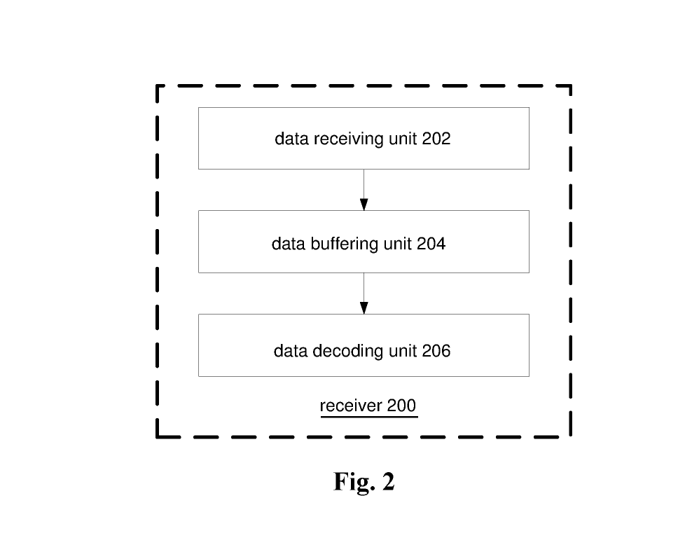

Referring to FIG. 1, the image processing method used in the image transmission system according to an embodiment of the present invention is illustrated. Referring to FIG. 2, a receiver used in the image transmission system according to the embodiment of the present invention will be further illustrated as follows, which is able to achieve the image processing method as shown in FIG. 1.

FIG. 2 is a block diagram showing the receiver used in the image transmission system according to the embodiment of the present invention. Referring to FIG. 2, the receiver 200 used in the image transmission system according to the embodiment of the present invention comprises: a data receiving unit 202, a data buffering unit 204, and a data decoding unit 206, wherein the data receiving unit 202 is for receiving a series of data encapsulations corresponding to a series of images from the transmitter, namely executing the step 102); the data buffering unit 204 is for buffering a pre-determined number of the data encapsulations according to a time order, namely executing the step 104); and the data decoding unit 206 is for decoding at least a part of the pre-determined number of the data encapsulations, namely executing the step 106).

According to the embodiment of the present invention, the receiver 200 does not need to decode all the data encapsulations corresponding to the images by, so as to decrease image transmission delay and achieve image transmission in almost real time.

Preferably, if a new data encapsulation is received before a first data encapsulation of the pre-determined number of the data encapsulations is decoded by the data decoding unit 206, the data buffering unit 204 discards the first data encapsulation and buffers the new data encapsulation. In such case, the pre-determined number of the data encapsulations may be decoded according to a buffering time order by the data decoding unit 206, or after a decoding process of a current data encapsulation is completed, other data encapsulations in the pre-determined number of the data encapsulations are ignored and the new data encapsulation is decoded. As a result, it is ensured that latest data encapsulations are buffered and decoded, so as to further improve real-time capability of image transmission.

Preferably, the part of the pre-determined number of the data encapsulations may be decoded, which can be a first half, a second half, a middle part, or discontinuously received ones of the pre-determined number of the data encapsulations. For example, a first pre-determined interval exists between receiving times of adjacent data encapsulations to be decoded in the part of the pre-determined number of the data encapsulations.

Preferably, when the data receiving unit 202 receives a series of the data encapsulations corresponding to a series of the images, the data encapsulations can be buffered by the data buffering unit 204 in sequence, or buffered once after skipping several data encapsulations or a certain period. For example, a first data encapsulation is buffered by the data buffering unit 204 after being received by the data receiving unit 202, a second and a third data encapsulations are discarded after being received by the data receiving unit 202, and then a fourth data encapsulation is buffered by the data buffering unit 204 after being received by the data receiving unit 202; or, a first data encapsulation is buffered by the data buffering unit 204 after being received by the data receiving unit 202, no data encapsulation is buffered within next 50 ms, and then a new data encapsulation is buffered after being received by the data receiving unit 202, and so on. That is to say, a second pre-determined interval may exist between receiving times of adjacent data encapsulations in the pre-determined number of the data encapsulations buffered by the data buffering unit 204.

Other features of the receiver 200 used in the image transmission system according to the embodiment of the present invention are the same as the image processing method as shown in FIG. 1, and will not be repeatedly described.

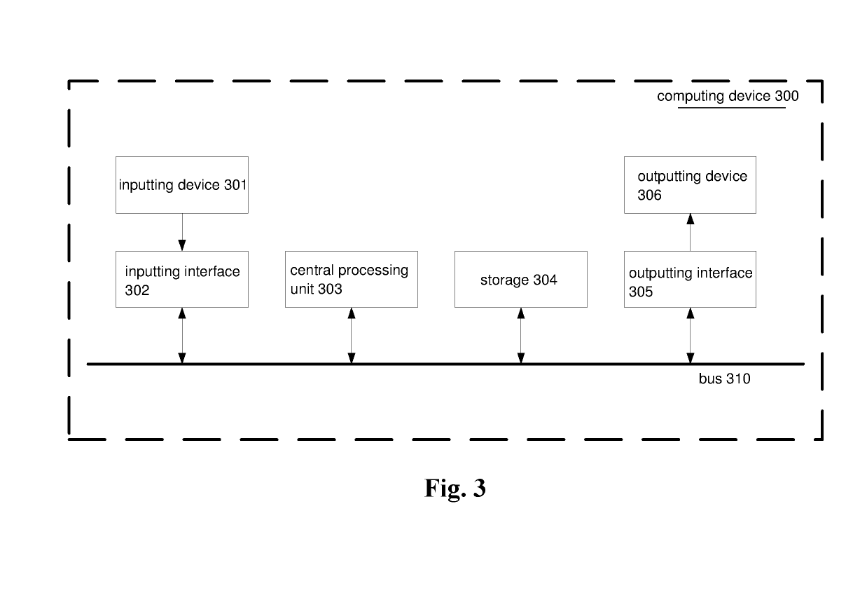

As least a part of the image processing method as shown in FIG. 1 and the receiver 200 as shown in FIG. 2 used in the image transmission system according to the embodiment of the present invention can be achieved by a computing device. FIG. 3 is a block diagram showing a hardware architecture of the computing device capable of implementing the image processing method shown in FIG. 1 and the receiver shown in FIG. 2. Referring to FIG. 3, the computing device 300 comprises an inputting device 301, an inputting interface 302, a central processing unit 303, a storage 304, an outputting interface 305, and an outputting device 306; wherein the inputting interface 302, the central processing unit 303, the storage 304, and the outputting interface 305 are connected to each other through a bus 310; the inputting device 301 and the outputting device 306 are respectively connected to the bus 310 through the inputting interface 302 and the output interface 305, so as to be connected to other components of the computing device 300.

Specifically, the inputting device 301 receives a series of data encapsulation from a transmitter, and sends to the storage 304 through the inputting interface 302; the storage 304 buffers a pre-determined number of the data encapsulations; the central processing unit 303 processes at least a part of the pre-determined number of the data encapsulations buffered by the storage 304 based on executable instructions in the storage 304, so as to restore images corresponding the data encapsulations; the restored images are temporarily or permanently stored in the storage 304, then are sent to the outputting device 306 through the outputting interface 305; and the outputting device 306 sends the restored images to a peripheral device of the computing device 300, such as a displayer for viewing.

That is to say, the receiver 200 as shown in FIG. 2 can be modified as: a storage with executable instructions, and a processor for achieving the image processing method as shown in FIG. 1 by executing the executable instructions.

It should be understood that the present invention is not limited to the particular configurations and processes described above and illustrated in the figures. For the sake of brevity, a detailed description of known methods is omitted here. In the above-described embodiments, several specific steps are described and illustrated as examples. However, the process of the present invention is not limited to the specific steps described and shown. Those skilled in the art can make various changes, modifications and additions or change the order of steps after understanding the spirit of the present invention.

The functional blocks shown in the block diagrams described above may be implemented as hardware, software, firmware, or a combination thereof. When implemented in hardware, it may for example be an electronic circuit, an application specific integrated circuit (ASIC), a suitable firmware, a plug-in, a function card or the like. When implemented in software, the elements of the present invention are programs or code segments used to perform the required tasks. The program or code segments may be stored in a machine-readable medium or transmitted over a transmission medium or communication link through data signals carried in the carrier wave. “Machine-readable medium” may include any medium capable of storing or transmitting information such as electronic circuits, semiconductor memory devices, ROM, flash memory, erasable ROM (EROM), floppy disks, CD-ROM, optical disks, hard disks, fiber optic media, radio frequency (RF) links, and the like. The code segments may be downloaded via a computer network, such as the Internet, an intranet, or the like.

The present invention may be embodied in other specific forms without departing from the spirit and essential characteristics thereof. For example, the algorithms described in the specific embodiments may be modified without departing from the basic spirit of the present invention. The embodiments are therefore to be considered in all respects as illustrative and not restrictive, the scope of the present invention should be defined by the appended claims rather than by the foregoing description, and such modifications as fall within the meaning and equivalents of the claims are within the scope of the present invention.

What is claimed is:

1. A receiver used in an image transmission system, wherein the image transmission system comprises a transmitter and the receiver; the receiver comprises:
a data receiving unit for receiving a series of data encapsulations corresponding to a series of images from the transmitter;
a data buffering unit for buffering a pre-determined number of the data encapsulations according to a time order; and
a data decoding unit for decoding at least a part of the pre-determined number of the data encapsulations.

2. The receiver, as recited in claim 1, wherein if a new data encapsulation is received before a first data encapsulation of the pre-determined number of the data encapsulations is decoded by the data decoding unit, the data buffering unit discards the first data encapsulation and buffers the new data encapsulation.

3. The receiver, as recited in claim 2, wherein after a decoding process of a current data encapsulation is completed, the data decoding unit ignores other data encapsulations in the pre-determined number of the data encapsulations and decodes the new data encapsulation.

4. The receiver, as recited in claim 1, wherein the data decoding unit decodes the part of the pre-determined number of the data encapsulations, and a first pre-determined interval exists between receiving times of adjacent data encapsulations in the part of the pre-determined number of the data encapsulations.

5. The receiver, as recited in claim 1, wherein a second pre-determined interval exists between receiving times of adjacent data encapsulations in the pre-determined number of the data encapsulations.

6. An image processing method used in an image transmission system, comprising steps of:
receiving a series of data encapsulations corresponding to a series of images;
buffering a pre-determined number of the data encapsulations according to a time order; and
decoding at least a part of the pre-determined number of the data encapsulations.

7. The image processing method, as recited in claim 6, wherein if a new data encapsulation is received before a first data encapsulation of the pre-determined number of the data encapsulations is decoded, the first data encapsulation is discarded and the new data encapsulation is buffered.

8. The image processing method, as recited in claim 7, wherein after a decoding process of a current data encapsulation is completed, other data encapsulations in the pre-determined number of the data encapsulations are ignored and the new data encapsulation is decoded.

9. The image processing method, as recited in claim 6, wherein the part of the pre-determined number of the data encapsulations are decoded, and a first pre-determined interval exists between receiving times of adjacent data encapsulations in the part of the pre-determined number of the data encapsulations.

10. The image processing method, as recited in claim 6, wherein a second pre-determined interval exists between receiving times of adjacent data encapsulations in the pre-determined number of the data encapsulations.
